(19) United States
(12) Patent Application Publication
(10) Pub. No.: US 2015/0319108 A1
(43) Pub. Date: Nov. 5, 2015

(54) RE-DRIVER FOR BIDRIECTIONAL UNIDRECTIONAL HIGH SPEED SIGNALING WHILE PERMITTING LOW SPEED BIDIRECTIONAL SIGNALING

(71) Applicant: TEXAS INSTRUMENTS INCORPORATED, Dallas, TX (US)

(72) Inventors: Win N. MAUNG, Plano, TX (US); Anwar SADAT, Richardson, TX (US); Charles M. CAMPBELL, McKinney, TX (US)

(21) Appl. No.: 14/268,625

(22) Filed: May 2, 2014

(51) Int. Cl. H04L 12/947; H04L 12/825

(52) U.S. Cl. CPC H04L 49/25; H04L 47/25

(57) ABSTRACT

A re-driver circuit includes a first channel comprising a receiver to receive an input signal from a first port to the re-driver circuit and a driver to receive a signal from the receiver and drive an output signal of the re-driver circuit through a second port. A second channel is also provided and is in parallel with the first channel and includes a bidirectional path switch. A channel control unit determines whether the input signal is indicative of a higher speed mode or of a lower speed mode and enables one of the first and second channels while disabling the other of the channels based on the determined mode. The first and second channels share the first and second ports.

### CROSS-REFERENCE TO RELATED APPLICATION

N/A.

### BACKGROUND

Communication links are prevalent in modern electronics. Some communication links are unidirectional (data flows in only one direction), while other links are bidirectional (data flows in both directions). Depending on the distances involved, a signal re-driver may be useful to boost the signal to thereby ensure the signal is properly and accurately received and decoded at the destination location along the communication link.

### SUMMARY

In some embodiments, a re-driver circuit includes a first channel comprising a receiver to receive an input signal from a first port to the re-driver circuit and a driver to receive a signal from the receiver and drive an output signal of the re-driver circuit through a second port. A second channel is also provided and is in parallel with the first channel and includes a bidirectional path switch. A channel control unit determines whether the input signal is indicative of a higher speed mode or of a lower speed mode and enables one of the first and second channels while disabling the other of the channels based on the determined mode. The first and second channels share the first and second ports.

### BRIEF DESCRIPTION OF THE DRAWINGS

For a detailed description of exemplary embodiments of the invention, reference will now be made to the accompanying drawings in which:

FIG. 1 shows a block diagram of a communication link which includes a re-driver accordance with various embodiments;

FIG. 2 shows an example of the re-driver of FIG. 1; and

FIG. 3 shows another example of the re-driver of FIG. 1.

### DETAILED DESCRIPTION

The following discussion is directed to various embodiments of the invention. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

Some communication links include provisions for both unidirectional signaling and bidirectional signaling. For example, the Mobile Industry Processor Interface (MIPI) standards body has promulgated a D-PHY Specification that provides a flexible, low-cost high-speed communication path for use in a mobile device such as a camera. The D-PHY interface may be used to connect the camera's sensing device to a processor internal to the camera. The high-speed communication path is unidirectional and typically conveys image data from the camera's sensor to the processor.

The D-PHY interface also includes a lower speed bi-directional communication path. This lower-speed, bi-directional communication path is referred to as a “low power” (LP) signal path, and may be particularly useful for transmitting control signals. The lower-speed, bi-directional communication path shares the same conductors (e.g., wires) as the higher-speed communication path.

The distances involved in transmitting data within a device such as a camera or smart phone are short enough that a re-driver is not needed. However, problems occur when attempting to extend the D-PHY or similar interfaces to larger devices over longer distances. For example, the distance involved from a laptop computer's camera, which is typically at the top center of the display, through the display, through the hinge, and to the computer's main system board is large enough that a signal re-driver may be needed. A signal re-driver that works to properly drive a higher-speed signal in one direction, however, is likely not usable for the lower-speed mode which shares the same signal conductors as the higher-speed mode.

In accordance with the preferred embodiments, a re-driver circuit is provided which provides a receiver and driver combination for a high-speed mode, and a bypass path for the lower-speed mode. The bypass path for the lower-speed mode bypasses the receiver/driver path. The re-driver detects whether signaling commensurate with the higher-speed mode or with the lower-speed mode is occurring or is about to occur. If the signaling commensurate with the higher-speed is occurring or is about to occur, the re-driver enables the higher-speed communication path and disables the bypass communication path. Conversely, if the signaling commensurate with the lower-speed is occurring or is about to occur, the re-driver disables the higher-speed communication path and enables the bypass communication path.

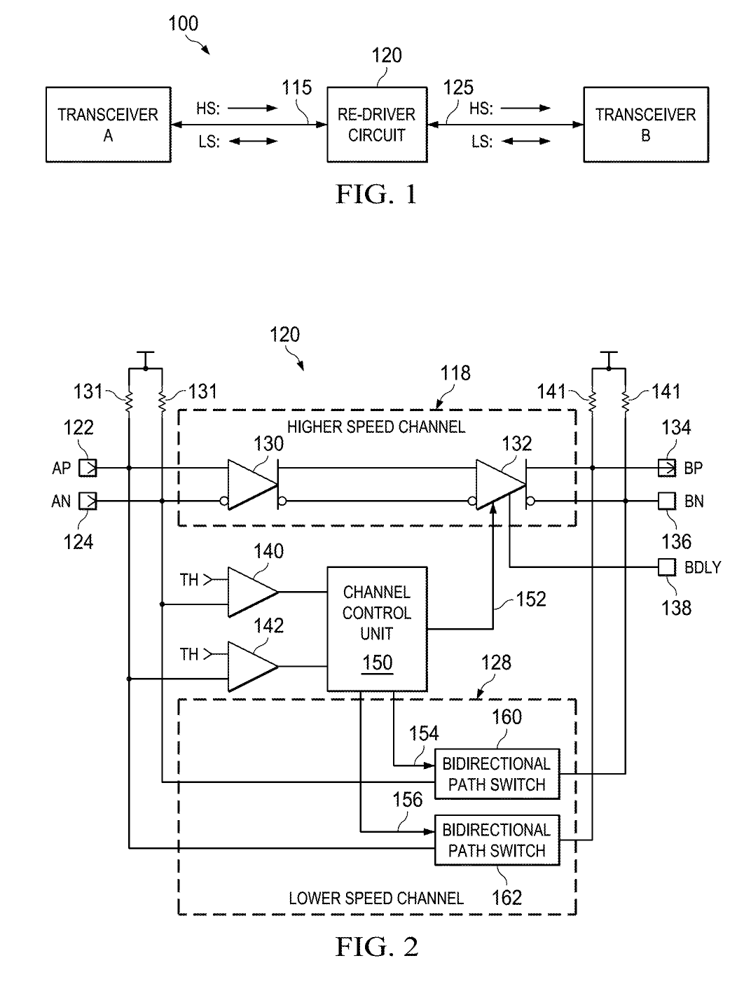

FIG. 1 illustrates an example of a system 100 which includes a pair of transceivers in communication with each other. The pair of transceivers includes transceiver A and transceiver B. A re-driver circuit 120 is electrically disposed between the transceivers. Each transceiver A and B is capable of sending and receiving data. Re-driver circuit 120 is coupled to transceiver A via a communication link 115 and to transceiver B via communication link 125. Each communication link 115, 125 is configured to provide a higher-speed (HS) data path and a lower-speed (LS) data path. No restriction is hereby placed on the data rates of the higher and lower-speed paths. The higher-speed path is simply a higher data rate than the lower-speed path.

As indicated in the example of FIG. 1, the higher-speed data path is a uni-directional path in that data on the higher-speed path is from transceiver A to transceiver B through the re-driver circuit 120. Further, the lower-speed data path is bi-directional as indicated.

FIG. 2 shows an example of the re-driver circuit 120. The re-driver circuit 120 of FIG. 2 includes a first channel 118 designated as the “higher-speed channel” and a second channel 128 designated as the “lower-speed channel.” The inputs to and outputs from the re-driver circuit 120 include first ports 122 and 124 and second ports 134 and 136. First ports 122, 124 are designated as AP and AN, respectively, and second ports 134, 136 are designated as BP and BN, respectively.

The higher-speed channel 118 is unidirectional and includes a receiver 130 coupled to a driver 132. The receiver 130 receives an input signal from first ports 122 and 124. The driver 132 receives a signal from the receiver 130 and drives an output signal of the re-driver circuit through second signal ports 134, 136. The higher-speed channel 118 preferably is a differential communication path as shown.

The lower-speed channel 128 preferably is bidirectional and bypasses the receiver 130 and driver 132 of the higher-speed channel. The lower-speed channel 128 includes a pair of bidirectional path (BDP) switches 160 and 162. Switch 160 is coupled to the signal line of the AP-BP signal, and switch 162 is coupled to the signal line of the AN-BN signal. Due to the bidirectional nature of the lower-speed channel 128, a signal may be transmitted through the re-driver circuit 120 in either direction—from ports 122, 124 to ports 134, 136, or vice versa—through the switches 160 and 162.

The higher-speed channel 118 and the lower-speed channel 128 share the same ports 122, 124, 134, and 136 for their signaling.

To implement the re-driver functionality for the higher-speed channel signaling while still permitting bidirectional signaling on the lower-speed channel, a channel control unit 150 is provided. The channel control unit 150 determines whether higher-speed signaling is occurring or is about occur, or whether lower-speed signaling is occurring or is about to occur. As a result of that determination, the channel control unit 150 enables the corresponding higher-speed or lower-speed channel. Thus, if higher-speed signaling is occurring or is about occur, the channel control unit 150 enables the higher-speed channel 118 while disabling the lower-speed channel 128, but if lower-speed signaling is occurring or is about occur, the channel control unit 150 enables the lower-speed channel 128 while disabling the higher-speed channel 118.

The channel control unit 150 examines the signals on the AP and AN ports 122 and 124 to determine whether higher-speed signaling is occurring or is about occur, or whether lower-speed signaling is occurring or is about to occur. Thus, the channel control unit 150 determines whether an input signal is indicative of a higher speed mode or of a lower speed mode and enables one of the first and second channels while disabling the other of the channels based on the determined mode. A buffer 140 is coupled to port 122 and provides a signal to the channel control unit 150 indicative of signal AP. A buffer 142 is coupled to port 122 and provides a signal to the channel control unit 150 indicative of signal AP. The channel control unit 150 examines the outputs of buffers 140 and 142 (indicative of signals AP and AN) to detect the occurrence of the higher speed mode or the lower speed mode.

In some embodiment, the higher-speed signaling mode is characterized by low common mode voltage and small voltage swings (e.g., less than 450 mV), while the lower-speed signaling mode is characterized by larger voltage swings (e.g., greater than 450 mV) and higher common mode voltage. For example, a voltage threshold is provided as an input to each buffer 140/142, and the buffers 140, 142 function as comparators to compare their signal input (AP, AN) to a threshold voltage. The threshold voltages for buffers 140, 142 may be the same or different. Thus, the buffers 140, 142 and channel control unit 150 implements protocol detection logic to compare the AP and AN signals to threshold voltage to detect which mode is present. In one example, the voltage thresholds are defined by the MIPI D-PHY Specification (“MIPI® Alliance Specification for D-PHY Version 1.1—7 Nov. 2011). In one embodiment, the threshold voltage is set to a value of 450 mV.

Upon determining whether the higher-speed mode or the lower-speed mode is occurring, or about to occur, the channel control unit 150 asserts control signals on lines 152, 154, and 156 to enable and disable the corresponding channels 118 and 128. If the channel control unit 150 determines that the higher-speed mode is occurring or is about to occur, the channel control unit asserts a signal on line 152 to enable the driver 132 of the higher speed channel 118 to thereby pass a higher-speed signal through the higher-speed channel 118 from ports 122, 124 to ports 134, 136. The channel control unit 150 also asserts signals on lines 154 and 156 to switches 160 and 162, respectively, to disable the switches and thus to disables the lower-speed channel 128.

If the channel control unit 150 determines that the lower-speed mode is occurring or is about to occur, the channel control unit asserts a signal lines 154 and 156 to enable BDP switches 160, 162 to enable the lower-speed channel 128. The channel control unit 150 also asserts a signal on line 152 to disable the driver 132 of the higher speed channel 118 to thereby disable the higher-speed channel 118. Thus, only one of the channels 118, 128 is enabled at a time, and which channel is enabled depends on whether the channel control unit 10 detects signaling consistent with the higher-speed mode or the lower-speed mode. With the protocol level mode detection, the high speed signal conditioning provided by the receiver 130 and driver 132 preferably is activated only when needed during high-speed signaling and thus does not interfere during low speed signaling.

A delay port (BDLY) 138 is also provided and is connected to driver 132. An external resistor may be connected to the delay port 138 to tune the timing of the channel. The resistor provides a variable bias current for the delay cell in the data paths that controls the propagation delay through it.

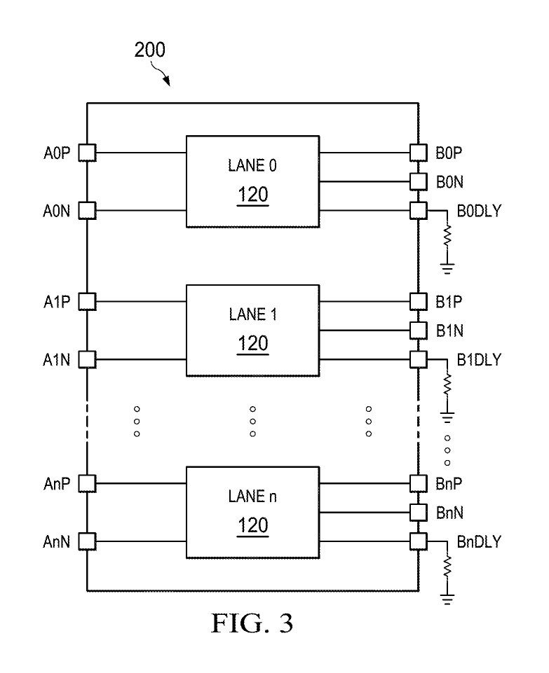

FIG. 3 shows another example of a re-driver assembly 200 which includes multiple lanes. Each lane in the example of FIG. 3 includes re-driver circuit 120, such as that depicted in FIG. 2. The ports for LANE 0 includes A0P, A0N, B0P, B0N, and B0DLY. The ports for the other lanes are designated similarly as shown.

Tuning resistors are also shown connected to the DLY ports (B0DLY, B1DLY, . . . ,BnDLY). The resistors are provided to allow a system designer to compensate for channel mismatch by tuning the individual channel timing.

The above discussion is meant to be illustrative of the principles and various embodiments of the present invention. Numerous variations and modifications will become apparent to those skilled in the art once the above disclosure is fully appreciated. It is intended that the following claims be interpreted to embrace all such variations and modifications.

What is claimed is:

1. A re-driver circuit, comprising:
a first channel comprising a receiver to receive an input signal from a first port to the re-driver circuit and a driver to receive a signal from the receiver and drive an output signal of the re-driver circuit through a second port;
a second channel in parallel with the first channel and comprising a bidirectional path switch; and
a channel control unit to determine whether the input signal is indicative of a higher speed mode or of a lower speed mode and to enable one of the first and second channels while disabling the other of the channels based on the determined mode;
wherein the first and second channels share the first and second ports.

2. The re-driver circuit of claim 1 wherein the driver of the first channel includes an enable input that is controllable by a control signal from the channel control unit and the bidirectional path switch includes a control input that is controllable by a control signal from the channel control unit.

3. The re-driver circuit of claim 1 wherein the receiver of the first channel is to receive a pair of differential input signals, and the second channel comprises a pair of bi-directional signal paths, each signal path comprising a bidirectional path switch controllable by the channel control unit.

4. The re-driver circuit of claim 1 wherein the first channel is a unidirectional channel and the second channel is a bidirectional channel.

5. The re-driver circuit of claim 1 further comprising a delay port to which a resistor is connectable to tune a delay of the re-driver circuit.

6. The re-driver circuit of claim 1 further comprising a plurality of lanes, each lane including:
a first channel comprising a receiver to receive an input signal from a first port to that lane and a driver to receive a signal from the receiver and drive an output signal of the lane through a second port;
a second channel in parallel with the first channel and comprising a bidirectional path switch; and
a channel control unit to determine whether the input signal is indicative of a higher speed mode or of a lower speed mode and to enable one of the first and second channels while disabling the other of the channels based on the determined mode;
wherein the first and second channels of each lane share the first and second ports of that lane.

7. A re-driver circuit, comprising:
a plurality of lanes, each lane comprising:
a unidirectional first channel comprising a receiver to receive an input signal from a first port to that lane and a driver to receive a signal from the receiver and drive an output signal of the lane through a second port;
a bidirectional second channel in parallel with the first channel and comprising a pair of bidirectional path switches; and
a channel control unit to determine whether the input signal is indicative of a higher speed mode or of a lower speed mode and to enable one of the first and second channels while disabling the other of the channels based on the determined mode; and
a delay port to which a resistor is connectable to tune a delay of the lane;
wherein the first and second channels share the first and second ports.

8. The re-driver circuit of claim 7 wherein the driver of the first channel of each lane includes an enable input that is controllable by a control signal from the channel control unit and the bidirectional path switches include a control input that is controllable by a control signal from the channel control unit.

9. A system, comprising:
a first transceiver;
a second transceiver; and
a re-driver circuit including:
a first channel comprising a receiver to receive an input signal from a first port to the re-driver circuit and a driver to receive a signal from the receiver and drive an output signal of the re-driver circuit through a second port;
a second channel in parallel with the first channel and comprising a bidirectional path switch; and
a channel control unit to determine whether the input signal is indicative of a higher speed mode or of a lower speed mode and to enable one of the first and second channels while disabling the other of the channels based on the determined mode;
wherein the first and second channels share the first and second ports.

10. The system of claim 9 wherein the driver of the first channel of each lane includes an enable input that is controllable by a control signal from the channel control unit and the bidirectional path switch includes a control input that is controllable by a control signal from the channel control unit.

11. The system of claim 9 wherein the receiver of the first channel of each lane is to receive a pair of differential input signals, and the second channel of each lane comprises a pair of bi-directional signal paths, each signal path comprising a bidirectional path switch controllable by the channel control unit.

12. The system of claim 9 wherein the first channel of each lane is a unidirectional channel and the second channel of each lane is a bidirectional channel.

13. The system of claim 9 further comprising a delay port in each lane to which a resistor is connectable to tune a delay of the re-driver circuit.

14. The system of claim 9 wherein the first channel of each lane is unidirectional and the second channel of each lane is bidirectional and transmits data at a lower rate than the first channel.
